(19) United States
(12) Patent Application Publication
(10) Pub. No.: US 2010/0238503 A1
(43) Pub. Date: Sep. 23, 2010

(54) PRINTING SYSTEM AND PRINTING APPARATUS TERMINAL

(75) Inventors: Kenji Sakuda, Suwa-shi (JP); Yasuhiro Oshima, Matsumoto-shi (JP); Takafumi Higuchi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/729,168

(22) Filed: Mar. 22, 2010

(30) Foreign Application Priority Data
Mar. 23, 2009 (JP) 2009-069779

(51) Int. Cl. G06F 3/12

(52) U.S. Cl. 358/1.15

(57) ABSTRACT

A printing system includes a contents terminal transmitting printable printing contents and a printing apparatus terminal receiving and printing the printing contents, which are connected to the printing system via an IP network.

### BACKGROUND

1. Technical Field

The entire disclosure of Japanese Patent Application No. 2009-069779, filed Mar. 23, 2009 is expressly incorporated by reference herein.

The present invention relates to a printing system and a printing apparatus terminal, and more particularly, to a printing system, which includes a contents terminal transmitting printable printing contents and a printing apparatus terminal printing the printing contents, in which the contents terminal and the printing apparatus terminal are connected to the printing system via an Internet Protocol (IP) network, and the printing apparatus terminal connected with the contents terminal transmits printable printing contents via an IP network, receives the printing contents from the contents terminal, and prints the received printing contents.

2. Related Art

In the related art, as such a printing apparatus terminal, a facsimile (FAX) or a printer-connected Personal Computer (PC) is known which prints print data received through a communication network such as a telephone line or the Internet. The FAX, which receives the print data through the telephone line, responds to a call using a FAX signal, and prints the print data whenever receiving the data or after storing the data in a memory. The PC, which receives the print data through the Internet, stores the print data in an external storage device such as a hard disc drive, and then reads and prints the print data stored in the external storage device by running a printing application program. In addition, technologies relating to the transmission of information through the network are known, which are described in the patent documents, such as JP-A No. 2005-109701, JP-A No. 2003-178028, and JP-T No. 2005-516320.

Recently, a Next Generation Network (NGN), which has the flexibility and economics of an Internet Protocol (IP) network while ensuring reliability and stability, has been proposed as a next-generation information communication network. The NGN uses the Session Initiation Protocol (SIP) as a protocol that generates, changes, and segments a session necessary for exchanging voice, image, or text messages with respect to two or more counterparts in application layers. In the establishment of the sessions between devices using the SIP, an offering terminal, which requests the establishment of a session, transmits an INVITE message to an answering terminal, which is requested for the establishment of the session, in which the INVITE message contains a Uniform Resource Identifier (URI) indicating the location of the answering terminal on a network. Then, the answering terminal transmits ‘200 OK,’ which is a state code approving the establishment of the session, to the offering terminal. Data transmission between the terminals after the establishment of the session is typically a push mode, in which the offering terminal performs one-sided data transmission. However, data transmission may not be performed properly in some cases, depending on the performance of the answering terminal. In particular, if the answering terminal is a printing apparatus that prints data while receiving it, it is necessary to perform data transmission in response to printing speed. In addition, if multiple printing contents are present, the printing apparatus may acquire only the list of the printing contents and receive and print a desired printing content later.

### SUMMARY

An advantage of some aspects of the invention is that a printing apparatus terminal and a method for controlling the same can receive and print printing contents properly by using an Internet Protocol (IP) network.

The printing apparatus terminal and a printing apparatus terminal of the present invention provide the following exemplary embodiments.

The printing system according to an exemplary embodiment of the invention may include a contents terminal transmitting printable printing contents and a printing apparatus terminal receiving and printing the printing contents, which are connected to the printing system via an IP network. The contents terminal may include a contents-side connection establishment processor which establishes a connection with the printing apparatus terminal via the IP network based on transmission and reception of a connection request message having printing identification information, which is for transmission and reception of the printing contents, a list transmitter which functions as a server in a server-client model and transmits a list of the printing contents to the printing apparatus terminal in response to a request from the printing apparatus terminal when the connection with the printing apparatus terminal is established based on the transmission of the connection request message having the printing identification information, and a contents transmitter, which functions as a client in the server-client model and sends an information request to the printing apparatus terminal when the connection with the printing apparatus terminal is established based on the reception of the connection request message having the printing identification information and which functions, if a reply from the printing apparatus terminal in response to the information request has inversion information, as a server in the server-client model from a point in time when the inversion information is recognized and transmits the printing contents to the printing apparatus terminal in response to a request from the printing apparatus terminal. The printing apparatus terminal may include a memory capable of temporarily storing data, a printing processor, which prints print data, a printing apparatus-side connection establishment processor, which establishes a connection with the contents terminal via the IP network based on transmission and reception of the connection request message having the printing identification information, a list receiver, which functions as a client in the server-client model and receives the list of printing contents from the contents terminal by sending a request for transmission of the list of printing contents to the contents terminal when the connection with the contents terminal is established based on the reception of the connection request message having the printing identification information, a contents receiver-and-printing controller, which functions as a server in the server-client model and sends a reply having the inversion information in response to the information request from the contents terminal when the connection with the contents terminal is established based on the transmission of the connection request message having the printing identification information, and which functions, from a point in time when the reply having the inversion information is sent, as a client in the server-client model, receives the printing contents from the contents terminal by sending a request for transmission of printing content included in the list of printing contents to the contents terminal, and controls the printing processor so that the received printing content is printed.

In the printing system according to an exemplary embodiment of the invention, when the connection between the contents terminal and the printing apparatus terminal is established via the IP network based on the processing in which the contents terminal transmits the connection request message having the printing identification information, which is for the transmission and reception of the printing contents, and the printing apparatus terminal receives the connection request message, the contents terminal functions as a server in the server-client model and the printing apparatus terminal functions as a client in the server-client model, so that the contents terminal transmits the list of the printing contents to the printing apparatus terminal in response to the request for the transmission of the list of the printing contents from the printing apparatus terminal. Afterwards, when the connection between the contents terminal and the printing apparatus terminal is established via the IP network based on the processing in which the printing apparatus terminal transmits the connection request message having the printing identification information, which is for the transmission and reception of the printing contents, and the contents terminal receives the connection request message, the contents terminal functions as a client in the server-client model and the printing apparatus terminal functions as a server in the server-client model, so that the contents terminal sends an information request to the printing apparatus terminal and the printing apparatus terminal sends a reply having inversion information to the contents terminal in response to the information request. The printing apparatus terminal functions as a client in the server-client model from the point in time when the reply having the inversion information is sent, and the contents terminal functions as a server in the server-client model from the point in time when the inversion information is recognized. In response to a request for the transmission of a printing content, included in the list of the printing contents, from the printing apparatus terminal, the contents terminal transmits the printing contents to the printing apparatus terminal. The printing apparatus terminal receives the printing content, transmitted from the contents terminal, and prints the received printing content. As such, in the case of transmitting and receiving the list of the printing contents, it is possible to perform the transmission and reception of the list of the printing contents depending on the performance of the printing apparatus terminal by allowing the contents terminal to function as a server in the server-client model and the printing apparatus terminal to function as a client in the server-client model, that is, by performing the transmission and reception of the list of the printing contents with the initiative of the printing apparatus terminal. In addition, in the case of transmitting and receiving the list of the printing contents, it is possible to perform the transmission and reception of the list of the printing contents with the initiative of the printing apparatus terminal. Specifically, the contents terminal functions as a client in the server-client model and the printing apparatus terminal functions as a server in the server-client model, so that the contents terminal sends the information request to the printing apparatus terminal. When the printing apparatus terminal sends a reply having the inversion information to the contents terminal in response to the information request, the contents terminal functions as a server in the server-client model and the printing apparatus terminal functions as a client in the server-client model. Thus, it is possible to print the printing contents by performing the transmission and reception of the printing contents depending on the performance of the printing apparatus terminal. This, as a result, makes it possible to more properly receive the printing contents via the IP network and to print the received printing contents. Herein, the IP network may be a Next Generation Network (NGN), or the connection establishment may be based on the Session Initiation Protocol (SIP).

In an exemplary embodiment of the printing system, the contents receiver-and-printing controller of the printing apparatus terminal may receive data multiple times by sending, multiple times, a data transmission request for an amount of data to the contents terminal, the amount being in the range of a printing memory capacity, which is allocated to the print data, of the total memory capacity of the memory, and may control, whenever the data is received, the printing processor so that the received data is printed by the printing processor. Also, the printing contents transmitter of the contents terminal may transmit the printing contents by transmitting the data multiple times in response to the data transmission request from the printing apparatus terminal. As such, the printing apparatus terminal can receive data multiple times at a certain amount in the range of a printing memory capacity, which is allocated to the print data, of the total memory capacity of the memory, and print the respective received data. As a result, even if the printing memory capacity is small, the printing apparatus terminal can receive and print the printing contents properly by using the IP network.

In an exemplary embodiment of the printing system, the contents receiver-and-printing controller of the printing apparatus terminal may acquire, if a description document, which describes location information indicating a storage location of an image data included in the printing contents, is included, the image data based on the location information described in the description document. Herein, the description document may be, for example, XHTML-Print.

The printing apparatus terminal according to an exemplary embodiment of the invention is connected with a contents terminal, which transmits printable printing contents, via an IP network, receives the received printing contents from the contents terminal and prints the contents. The printing apparatus terminal may include a memory capable of temporarily storing data; a printing processor printing print data; a receiving-side connection establishment processor which establishes a connection with the contents terminal via the IP network based on transmission and reception of a connection request message having printing identification information, which is for transmission and reception of the printing contents; a list acquirer which acquires a list of the printing contents; and a contents receiver-and-printing controller which functions as a server in the server-client model and sends a reply having the inversion information in response to an information request from the contents terminal when the connection with the contents terminal is established based on the transmission of the connection request message having the printing identification information and which functions, from a point in time when the reply having the inversion information is sent, as a client in the server-client model, receives the printing contents from the contents terminal by sending a request for transmission of printing content included in the list of printing contents to the contents terminal, and controls the printing processor so that the received printing content is printed.

In the printing apparatus terminal according to an exemplary embodiment of the invention, when the connection between the contents terminal and the printing apparatus terminal is established via the IP network based on the processing in which the printing apparatus terminal transmits the connection request message having the printing identification information, which is for the transmission and reception of the printing contents, and the contents terminal receives the connection request message, the contents terminal functions as a client in the server-client model and the printing apparatus terminal functions as a server in the server-client model, so that the printing apparatus terminal sends a reply having inversion information to the contents terminal in response to an information request from the contents terminal. The printing apparatus terminal functions as a client in the server-client model from the point in time when the reply having the inversion information is sent and the contents terminal functions as a server in the server-client model from the point in time when the inversion information is recognized. In response to a request for the transmission of a printing content to the contents terminal, included in the list of the printing contents acquired with respect to the contents terminal, the contents terminal transmits the printing contents to the printing apparatus terminal. The printing apparatus terminal receives the printing content, transmitted from the contents terminal, and prints the received printing content. As such, in the case of transmitting and receiving the printing contents, it is possible to perform the transmission and reception of the printing contents with the initiative of the printing apparatus terminal. Specifically, the contents terminal functions as a client in the server-client model and the printing apparatus terminal functions as a server in the server-client model, so that the contents terminal sends the information request to the printing apparatus terminal. When the printing apparatus terminal sends a reply having the inversion information to the contents terminal in response to the information request, the contents terminal functions as a server in the server-client model and the printing apparatus terminal functions as a client in the server-client model. Thus, it is possible to print the printing contents by performing the transmission and reception of the printing contents depending on the performance of the printing apparatus terminal. This, as a result, makes it possible to more properly receive the printing contents via the IP network and to print the received printing contents. Herein, the IP network may be an NGN, or the connection establishment may be based on the SIP.

In an exemplary embodiment of the printing apparatus terminal, the list acquirer may function as a client in the server-client model and receive the list of printing contents from the contents terminal by sending a request for transmission of the list of printing contents to the contents terminal when the connection with the contents terminal is established based on the reception of the connection request message having the printing identification information. As such, it is possible to acquire the list of the printing contents from the contents terminal with the initiative of the printing apparatus terminal by allowing the contents terminal to function as a server in the server-client model and the printing apparatus terminal to function as a client in the server-client model.

In addition, in an exemplary embodiment of the printing apparatus terminal, the contents receiver-and-printing controller may receive data multiple times by sending, multiple times, a data transmission request for an amount of data to the contents terminal, the amount being in a range of a printing memory capacity of a memory capacity of the memory, which is allocated to the print data, and control, whenever the data is received, the printing processor so that the received data is printed by the printing processor. As such, the printing apparatus terminal can receive data multiple times at a certain data amount in the range of a printing memory capacity, which is allocated to the print data, of the total memory capacity of the memory, and print the respective received data. As a result, even if the printing memory capacity is small, the printing apparatus terminal can receive and print the printing contents properly by using the IP network.

Moreover, in an exemplary embodiment of the printing apparatus terminal, the contents receiver-and-printing controller may acquire, if a document, which describes location information indicating a storage location of an image data included in the printing contents, is included, the image data based on the location information described in the document. Herein, the description document may be, for example, XHTML-Print.

### BRIEF DESCRIPTION OF THE DRAWINGS

The invention will be described with reference to the accompanying drawings, wherein like numbers reference like elements.

FIG. 1 is an explanatory view showing a printing system according to an exemplary embodiment of the invention.

FIG. 2 is an explanatory view showing communication sequences in the transmission and reception of a list of printing contents.

FIG. 3 is an explanatory view showing an example of the contents of an SDP in an INVITE message.

FIG. 4 is an explanatory view showing an example of the contents of an SDP in a 200 OK message.

FIG. 5 is a flowchart showing printing apparatus-side processing in the transmission and reception of a list.

FIG. 6 is a flowchart showing contents-side processing in the transmission and reception of a list.

FIG. 7 is an explanatory view showing sequences in the transmission and reception of a list of printing contents.

FIG. 8 is an explanatory view showing an example of the contents of a capability request in sequence [11].

FIG. 9 is an explanatory view showing an example of a capability reply in sequence [12].

FIG. 10 is an explanatory view showing an example of the contents of a page information request in sequence [13].

FIG. 11 is an explanatory view showing an example of the contents of a page information reply in sequence [14].

FIG. 12 is an explanatory view showing an example of the contents of a data request in sequence [15].

FIG. 13 is an explanatory view showing an example of the contents of a data reply in sequence [16].

FIG. 14 is an explanatory view showing an example of a page information reply in sequence [17].

FIG. 15 is an explanatory view showing an example of communication sequences in the transmission and reception of printing contents.

FIG. 16 is a flowchart showing printing apparatus-side processing in the transmission and reception of printing contents.

FIG. 17 is a flowchart showing contents-side processing in the transmission and reception of printing contents.

FIG. 18 is an explanatory view showing sequences in the transmission and reception of printing contents.

FIG. 19 is an explanatory view showing an example of the contents of a capability request in sequence [21].

FIG. 20 is an explanatory view showing an example of the contents of a capability reply in sequence [22].

FIG. 21 is an explanatory view showing an example of the contents of a page information request in sequence [23].

FIG. 22 is an explanatory view showing an example of the contents of a page information reply in sequence [24].

FIG. 23 is an explanatory view showing an example of the contents of a data request in sequence [25].

FIG. 24 is an explanatory view showing an example of the contents of a data reply in sequence [26].

FIG. 25 is an explanatory view showing an example of an XHTML-Print document.

FIG. 26 is an explanatory view showing an example of the contents of a data request in sequence [27].

FIG. 27 is an explanatory view showing an example of the contents of a data reply in sequence [28].

FIG. 28 is an explanatory view showing an example of the contents of a page information reply in sequence [29].

### DESCRIPTION OF EXEMPLARY EMBODIMENTS

Hereinafter, exemplary embodiments of the present invention will be described.

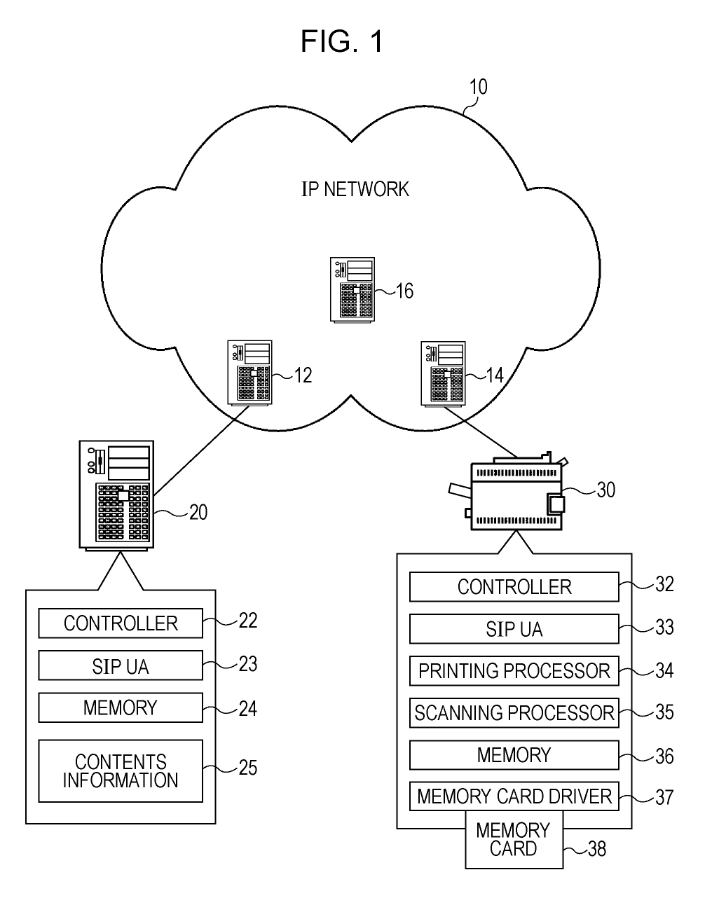

FIG. 1 is a configuration view showing an example of the configuration of a printing system, which includes a printing apparatus terminal 30 serving as a printing apparatus terminal according to an exemplary embodiment of the invention, a posting server 20, and an Internet Protocol (IP) network 10, to which both the printing apparatus terminal 30 and the posting server 20 are connected. As shown in the figure, the posting server 20 is connected to a Session Initiation Protocol (SIP) proxy server 12 of the IP network 10, and the printing apparatus terminal 30 is connected to an SIP proxy server 14 of the IP network 10.

The IP network 10 is constructed as, for example, a Next Generation Network (NGN), and includes the SIP proxy servers 12 and 14, a location server 16, or the like. The SIP proxy servers 12 and 14 not only relay an IP message but also function as registrars that register location information (e.g., Uniform Resource Identifier (URI)) of user agents 23 and 33 of the posting server 20 and the printing apparatus terminal 30 in the location server 16.

The posting server 20 includes a controller 22, which controls the entire server, a user agent (SIPUA) 23, which is for the SIP, a memory 24, which temporarily stores data, and a storage device 25, which stores information on printing contents such as information on a location where the printing contents are stored and information on a location where a list of the printing contents is stored.

The printing apparatus terminal 30 is constructed as a multifunction machine that can function as both a scanner and a printer, and includes a controller 32, which controls the entire apparatus, a user agent (SIPUA) 33, which is for the SIP, a printing processor 34, which prints text data, an image data, or the like, a scanning processor 35, which obtains the image data by scanning texts, images, or the like on a medium such as a sheet of paper, a memory 36, which temporarily stores data to be printed or the image data obtained by scanning, a memory card driver 37, which writes data in a memory card 38 or reads data stored in the memory card 38 when connected to the memory card 38, and the like.

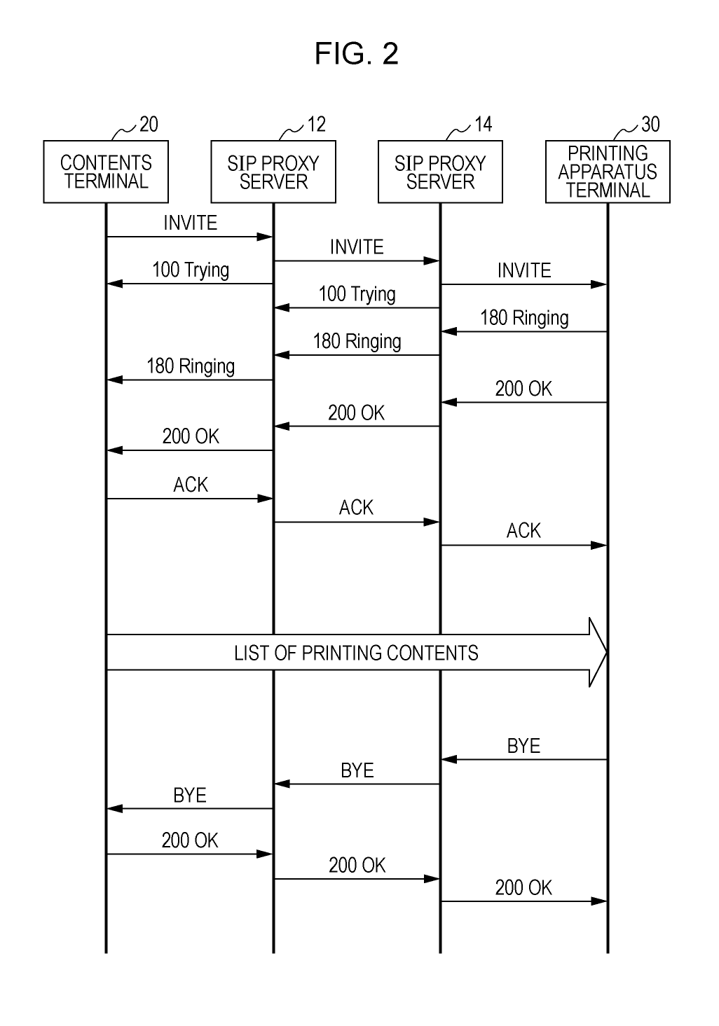

FIG. 2 is an explanatory view showing communication sequences between the posting server 20 and the printing apparatus terminal 30 using the SIP when a list of printing contents is transmitted from the posting server 20 to the printing apparatus terminal 30. The session establishment based on the SIP is initiated primarily by the posting server 20 transmitting an INVITE message to the printing apparatus terminal 30. The INVITE message from the posting server 20 is transmitted primarily to the SIP proxy server 12. The SIP proxy server 12 transmits a reply ‘100 Trying,’ which is a state code indicating that the message is being processed, to the posting server 20 and, based on the URI of the printing apparatus terminal 30 described in the INVITE message, transmits the INVITE message to the SIP proxy server 14. The SIP proxy server 14 transmits a reply ‘100 Trying,’ which is a state code indicating that the message is being processed, to the SIP proxy server 12 and, based on the URI of the printing apparatus terminal 30 written in the INVITE message, transmits the INVITE message to the printing apparatus terminal 30. The printing apparatus terminal 30, upon receiving the INVITE message, transmits a reply ‘180 Ringing,’ which is a state code indicating that it is being called. The reply ‘180 Ringing’ is transmitted to the posting server 20 through the SIP proxy server 14 and the SIP proxy server 12. Afterwards, when the printing apparatus terminal 30 transmits ‘200 OK,’ which is a state code indicating a success with respect to a session establishment call, in response to the received INVITE message, this ‘200 OK’ is transmitted to the posting server 20 through the SIP proxy server 14 and the SIP proxy server 12. Upon receiving the ‘200 OK,’ the posting server 20 transmits ‘ACK,’ which is a state code indicating an acknowledgment of the final reply to the INVITE message, to the printing apparatus terminal 30 through the SIP proxy server 12 and the SIP proxy server 14. Through the above processing, the connection between the posting server 20 and the printing apparatus terminal 30 is established, and the list of printing contents can be transmitted from the posting server 20 to the printing apparatus terminal 30. In addition, when the posting server 20 ends transmitting the list of printing contents, the printing apparatus terminal 30 transmits ‘BYE,’ which is a state code for closing the session, to the posting server 20 through the SIP proxy server 14 and the SIP proxy server 12. In response to ‘BYE,’ the posting server 20 transmits ‘200 OK’ to the printing apparatus terminal 30 through the SIP proxy server 12 and the SIP proxy server 14, thereby closing the session. Since the session is established and closed through the SIP proxy server 12 and the SIP proxy server 14, an operator of the SIP proxy server 12 and the SIP proxy server 14 can calculate a price (i.e., charge a fee) for the service of the session establishment to the posting server 20 or the printing apparatus terminal 30 by acquiring the date and time of the session establishment and the date and time of the session closing between the posting server 20 and the printing apparatus terminal 30.

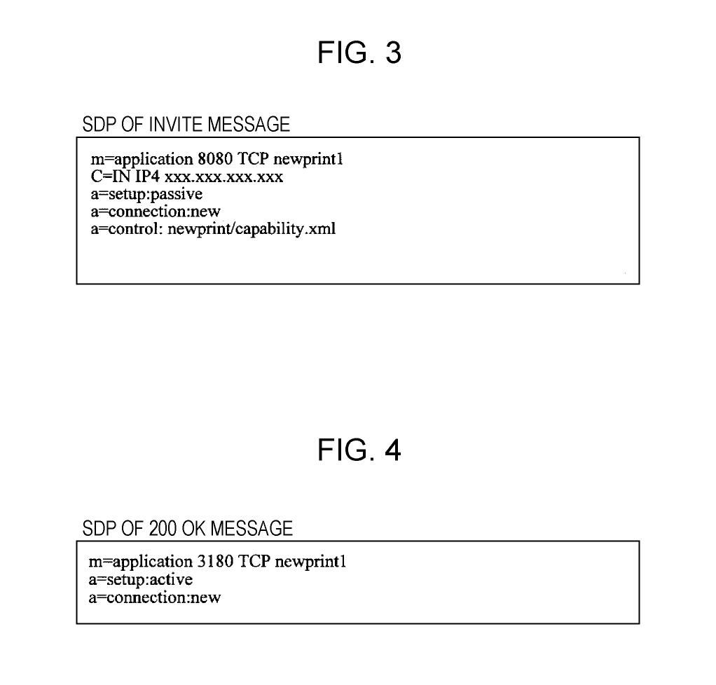

FIG. 3 is an explanatory view showing an example of the contents of a Session Description Protocol (SDP) in the INVITE message, transmitted from the posting server 20 according to an exemplary embodiment of the invention, and FIG. 4 is an explanatory view showing an example of the contents of an SDP in the ‘200 OK’ message, transmitted from the printing apparatus terminal 30 according to an exemplary embodiment of the invention. The SDP in FIGS. 3 and 4 forms media describing sections. In the SDP, line ‘m=’ indicates a media type or information of a transport address. Line ‘m=’ in FIG. 3 indicates that an application prescribed in payload type ‘newprint1’ using ‘Transmission Control Protocol (TCP)’ is treated by port number ‘8080.’ Line ‘m=’ in FIG. 4 indicates that an application prescribed in payload type ‘newprint1’ using ‘TCP’ is treated by port number ‘3180.’ In this exemplary embodiment, the description ‘newprint1’ in line ‘m=’ functions to identify as including the transmission and reception of the printing contents. Due to the description of ‘newprint1,’ the posting server 20 functions as a server in a server-client model, and the printing apparatus terminal 30 functions as a client in the server-client model. In addition, ‘a=setup:passive’ in FIG. 3 indicates that the posting server 20 functions as a ‘passive part’ (server), and ‘a=setup:active’ in FIG. 4 indicates that the printing apparatus terminal 30 functions as an ‘active part’ (client). In the SDP, line ‘C=’ indicates the address of medium included in the session. Line ‘C=’ in FIG. 3 indicates that the IP address of the posting server 20 is ‘xxx.xxx.xxx.xxx’ from the description ‘IN IP4 xxx.xxx.xxx.xxx.’ Also, a description ‘newprint/capability.xml’ in the last line ‘a=’ in FIG. 3 is an initial Uniform Resource Locator (URL) of a requesting part from the printing apparatus terminal 30 after the session is established. Due to this description, the printing apparatus terminal 30 which functions as a client in the server-client model can acquire the URL of a capability request, which is first requested to the posting server 20.

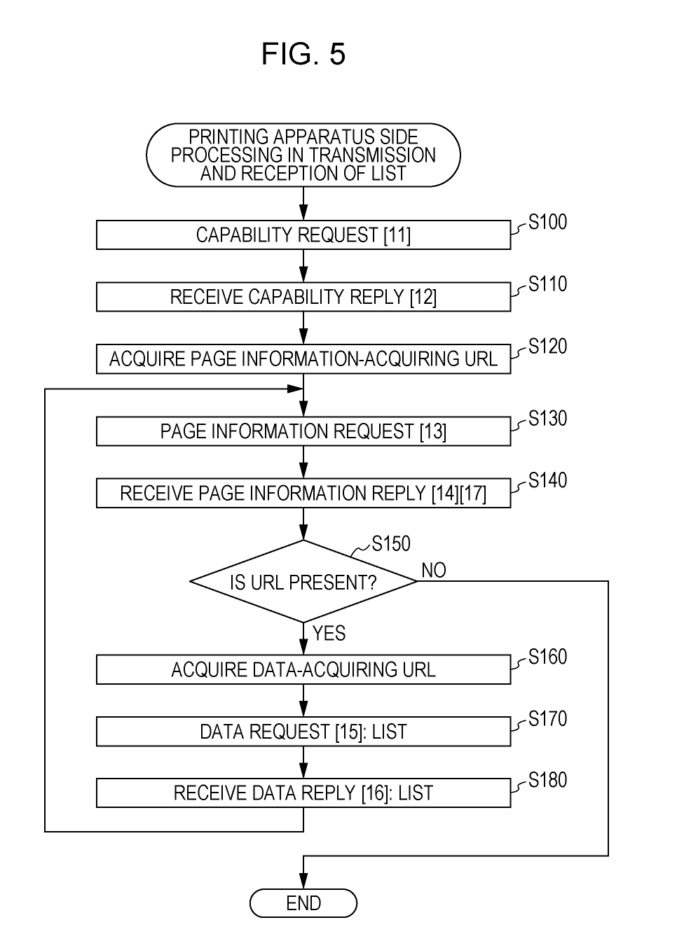

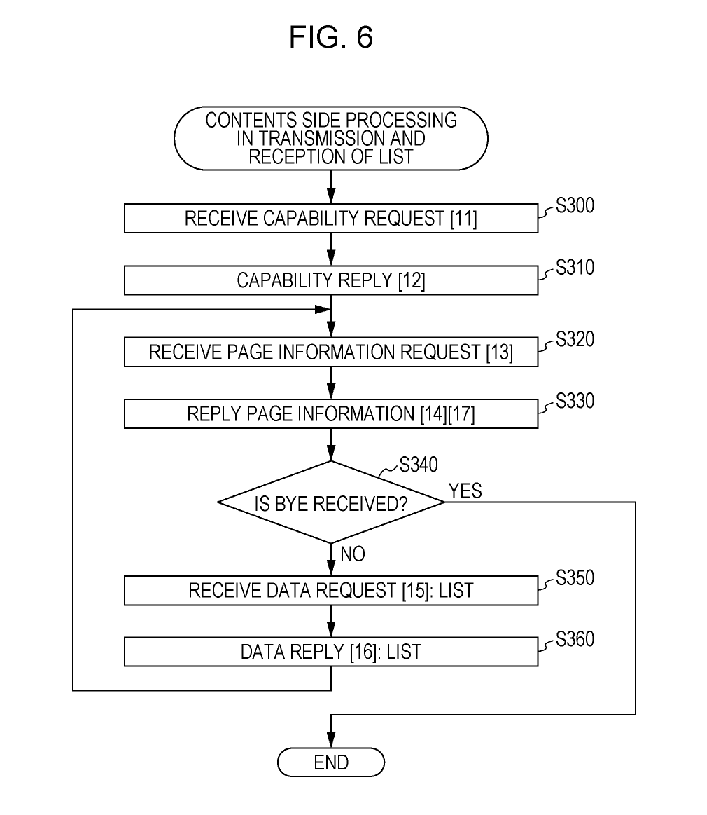

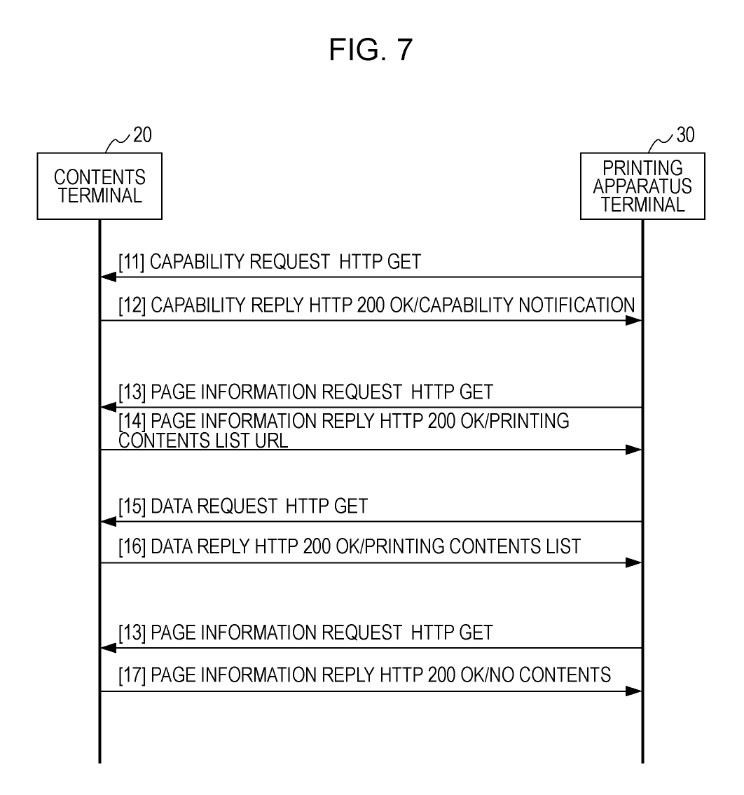

FIG. 5 is a flowchart showing an example of printing apparatus-side processing performed by the printing apparatus terminal 30 when a list of printing contents is transmitted from the posting server 20 to the printing apparatus terminal 30, FIG. 6 is a flowchart showing contents-side processing performed by the posting server 20 when the list of printing contents is transmitted from the posting server 20 to the printing apparatus terminal 30, and FIG. 7 is an explanatory view showing an example of sequences when a list of printing contents is transmitted from the posting server 20 to the printing apparatus terminal 30. For the sake of convenient explanation, a description will be given of the transmission and reception of the list of printing contents based on the sequences shown in FIG. 7, by referring to the printing apparatus-side processing in the transmission and reception of the list shown in FIG. 5 and the printing contents-side processing in the transmission and reception of the list shown in FIG. 6 if necessary. In addition, as described above, when a session for the transmission and reception of the list of printing contents is established, the posting server 20 functions as a server in a server-client model, and the printing apparatus terminal 30 functions as a client in the server-client model. Thus, the posting server 20 is standing by for a request from the printing apparatus terminal 30.

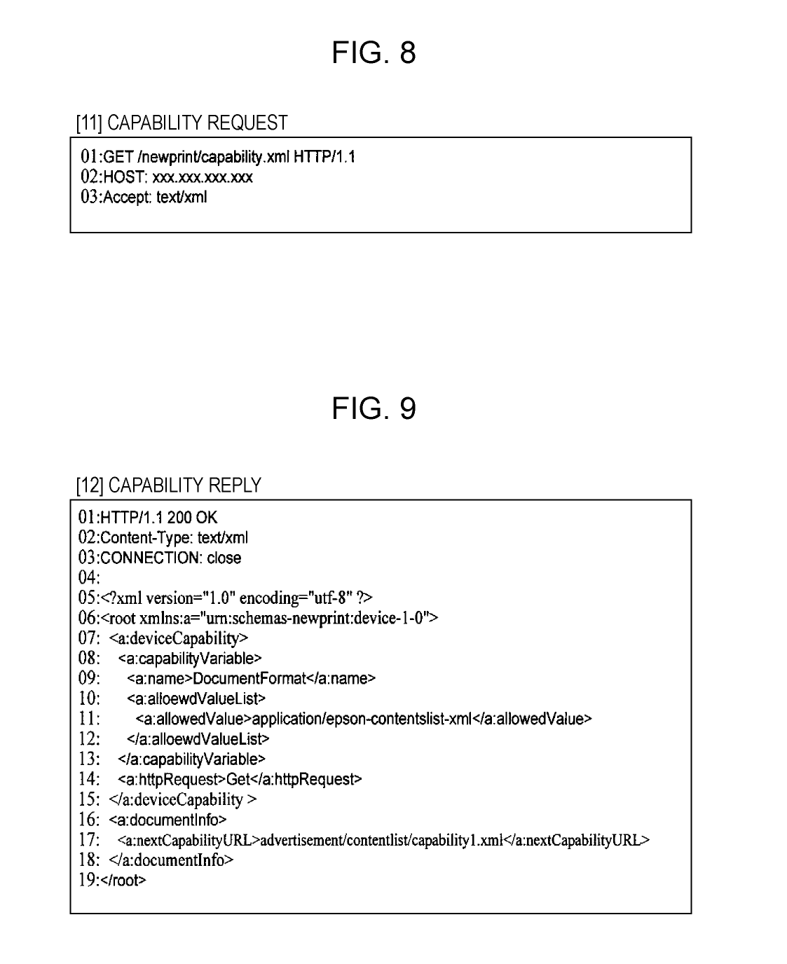

When the session is established, the printing apparatus terminal 30 performs a capability request by transmitting a capability request message to the posting server 20 (step S100 in FIG. 5 and step S300 in FIG. 6), and the posting server 20 performs a capability reply by transmitting a capability reply message to the printing apparatus terminal 30 in response to the capability request (step S310 in FIG. 6 and step S110 in FIG. 5). An example of the capability request message is shown in FIG. 8. In the capability request message, line 01 indicates a command indicating a ‘request,’ line 02 indicates the IP address of the posting server 20, which can be acquired from the INVITE message, and line 03 indicates the acceptance of an Extensible Markup Language (XML) text. An example of the capability reply message is shown in FIG. 9. In the capability reply message, line 01 is ‘200 OK’ that indicates a success with respect to the request, and line 02 indicates that the type of contents is an XML text. In addition, as for the capability of the posting server 20, it can be seen that a documentary format (‘DocumentFormat’ in line 09) is a list of contents (‘application/epson-contentslist-xml’ in line 11). Line 17 of the capability reply message describes a URL (‘advertisement/contentlist/capability1.xml’ in line 17) for the later requesting of page information from the printing apparatus terminal 30. The URL is a relative address with respect to the IP address ‘xxx.xxx.xxx.xxx’ (‘HOST:xxx.xxx.xxx.xxx’ in line 02 of FIG. 8) of the posting server 20, which is described with respect to the SDP in the INVITE message. When the capability reply message is received from the posting server 20, the printing apparatus terminal 30 acquires the capacity of the posting server 20 from the capacity reply message while acquiring the URL (‘advertisement/contentlist/capability1.xml’ in line 17), which describes initial page information of the list of printing contents (step S120 in FIG. 5).

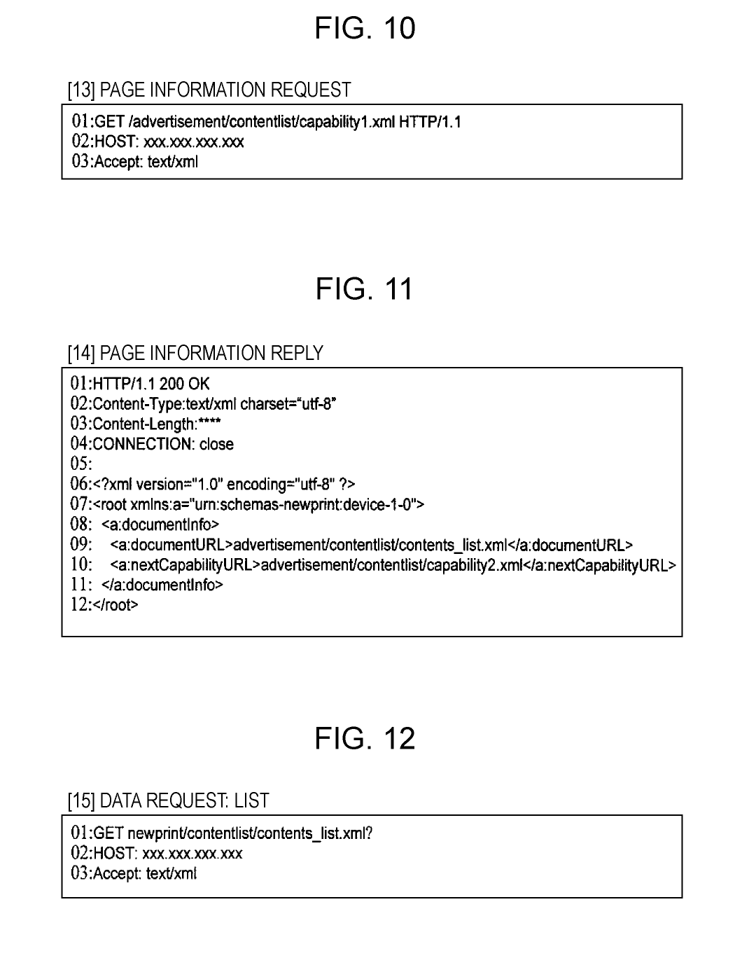

Afterwards, the printing apparatus terminal 30 performs a page information request by transmitting a page information request message using the acquired URL (‘advertisement/contentlist/capability1.xml’ in line 17 of the capability reply message in FIG. 9) to the posting server 20 (step S130 in FIG. 5 and step S320 in FIG. 6), and the posting server 20 performs a page information reply by transmitting a page information reply message to the printing apparatus terminal 30 (step S330 in FIG. 6 and step S140 in FIG. 5). An example of the page information request message is shown in FIG. 10. It can be seen that ‘advertisement/contentlist/capability1.xml’ described in line 01 of the page information request message is the same as ‘advertisement/contentlist/capability1.xml’ in line 17 of the capability reply message in FIG. 9. An example of the page information reply message is shown in FIG. 11. It can be seen that line 09 of the page information reply message describes the URL ‘advertisement/contentlist/contents_list.xml’ of the list of printing contents, and that line 10 describes the URL ‘advertisement/contentlist/capability2.xml’ of the next page in the list of printing contents. When the page information reply message is received from the posting server 20, the printing apparatus terminal 30 acquires the URL of the list of printing contents and/or the URL of the next page in the list of printing contents from the page information reply message if they are present in the page information reply message (step S150 and S160 in FIG. 5).

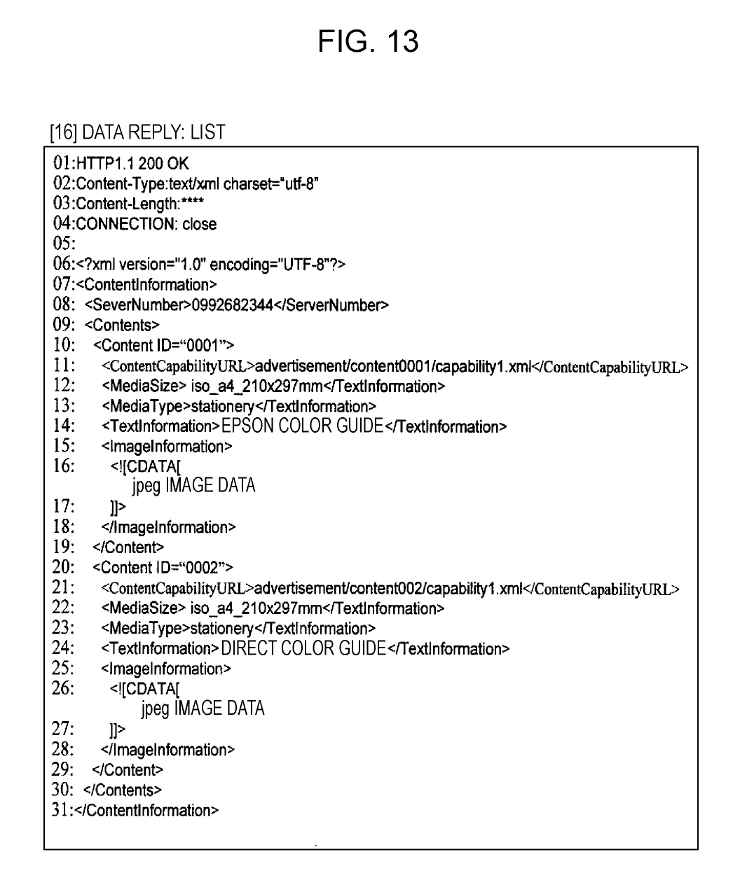

Next, the printing apparatus terminal 30 performs a data request by transmitting a data request message to the posting server 20 using the acquired URL (‘advertisement/contentlist/contents_list.xml’ in line 09 of the page information reply message in FIG. 11) (step S170 in FIG. 5 and step S350 in FIG. 6), and the posting server 20 performs a data reply by transmitting a data reply message and data to the printing apparatus terminal 30 in response to the data request (step S360 in FIG. 6 and step S180 in FIG. 5). An example of the data request message is shown in FIG. 12. It can be seen that ‘advertisement/contentlist/contents_list.xml’ described in line 01 of the data request message is the same as ‘advertisement/contentlist/contents_list.xml’ in line 09 of the page information reply message in FIG. 11. An example of the data reply message is shown in FIG. 13. In the data reply message, ‘0992682344’ in line 08 indicates identification information (e.g., telephone numbers) of the posting server 20, and ‘Content ID=“0001”’ in line 10 and ‘Content ID=“0002”’ in line 20 indicate identification numbers of printing contents. The posting server 20 according to an exemplary embodiment of the invention transmits the list of multiple printing contents at the same time if the multiple printing contents have accumulated at that time. It can be seen that two printing contents such as an identification number 0001 and an identification number 0002 have accumulated in the example shown in FIG. 13. In addition, in the example shown in FIG. 13, ‘advertisement/content0001/capability1.xml’ in line 11 and ‘advertisement/content002/capability1.xml’ in line 21 indicate the URL of capacity information, which is for the acquiring of printing contents on the identification numbers 0001 and 0002 of the printing contents. Also, as for the identification numbers 0001 and 0002 of the printing contents, from line 12 and line 22 indicate that paper size is A4 ‘iso_a4_{—}210×297 mm’ and line 13 and line 23 indicate that media type is ‘stationery.’ In addition, as for the identification number 0001 of the printing contents, line 14 indicates that the title of the printing contents is ‘Epson Color Guide,’ and as for the identification number 0002 of the printing contents, line 24 indicates that the title of the printing contents is ‘Direct Color Guide.’ Furthermore, lines 16 and 17 and lines 26 and 27 are data that indicate a display device (not shown) of the printing apparatus terminal 30 as for the identification numbers 0001 and 0002 of the printing contents.

When the transmission and reception of the list of printing contents ends, a page information request is sent to the posting server 20 using the URL ‘advertisement/contentlist/capability2.xml’ (see line 10 in FIG. 11) of the next page, acquired by the page information reply of the posting server 20 in response to the page information request from the printing apparatus terminal 30 to the posting server 20 (step S130 in FIG. 5 and step S320 in FIG. 6). The posting server 20 sends a page information reply in response to the page information request (step S330 in FIG. 6 and step S140 in FIG. 5). If the URL of the list of printing contents or the URL of the next page in the list of printing contents is present, a data request and data reply with respect to the list of printing contents are performed again (see step S150 to S180 in FIG. 5 and step S340 to S360 in FIG. 6).

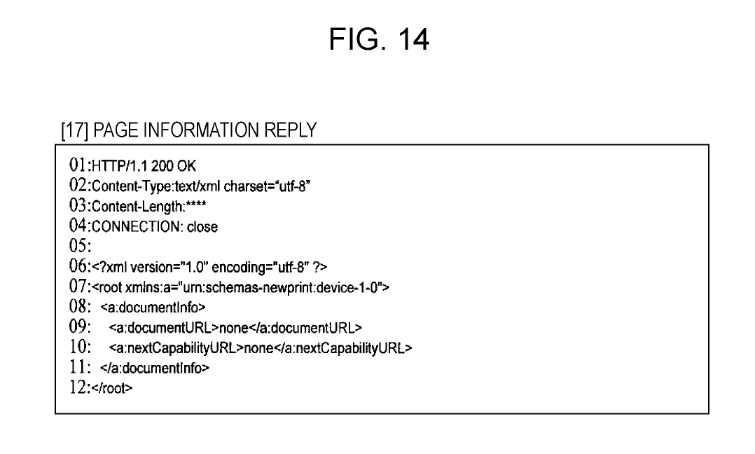

If neither URL of the list of printing contents nor URL of the next page is present in the page information reply message from the posting server 20, the printing apparatus terminal 30 determines that the transmission of the list of printing contents has ended (step S150 in FIG. 5), and transmits ‘BYE’ (see FIG. 2) to the posting server 20 in order to close the session. FIG. 14 shows an example of the page information reply message, which is transmitted from the posting server 20 in response to the page information request from the printing apparatus terminal 30 when the transmission of the list of printing contents is ended. ‘None’ in line 09 and ‘none’ in line 10 of the page information reply message indicate that neither URL of the list of printing contents nor URL of the next page is present. When ‘BYE’ is received (step S340 in FIG. 6), the posting server 20 transmits ‘200 OK’ to the printing apparatus terminal 30 in order to close the session. ‘BYE’ and ‘200 OK’ have been described above.

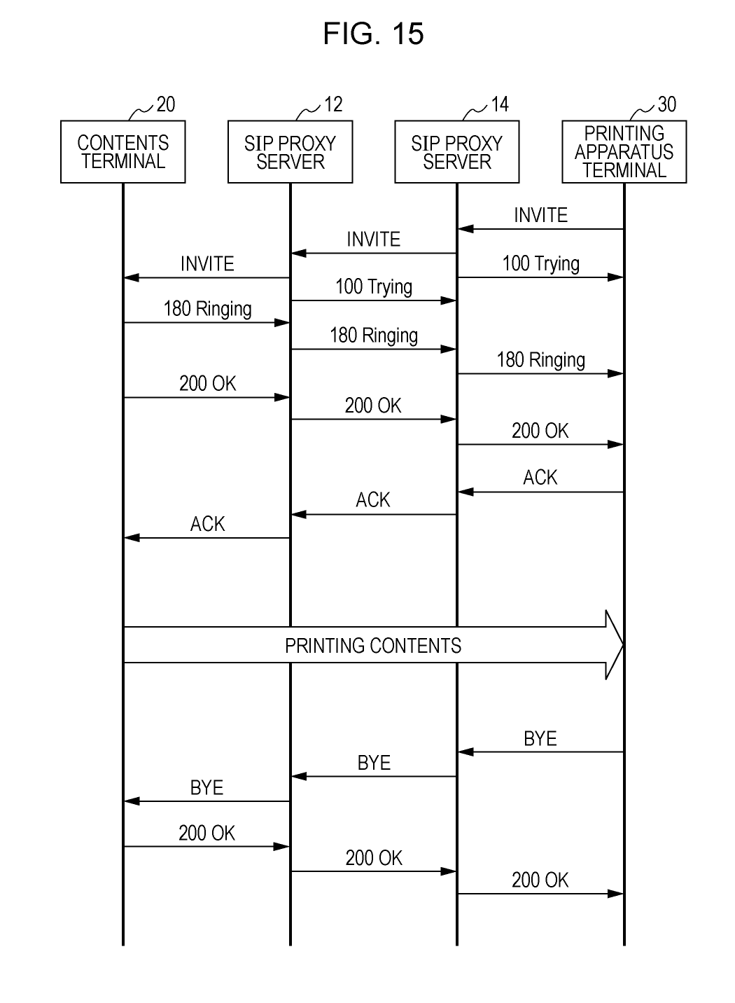

Next, a description will be given of processing in which the printing apparatus terminal 30 receives desired printing contents, selected from among the received list of printing contents, from the posting server 20 and prints the contents. In this case, the session is established when the printing apparatus terminal 30 transmits an INVITE message to the posting server 20 via the SIP proxy server 14 and the SIP proxy server 12 and when the posting server 20 transmits ‘180 Ringing’ or ‘200 OK’ to the printing apparatus terminal 30 via the SIP proxy server 12 and the SIP proxy server 14. FIG. 15 shows communication sequences of this processing. The contents of the SDP of the INVITE message transmitted from the printing apparatus terminal 30 and the contents of the SDP in the ‘200 OK’ message transmitted from the posting server 20 are the same as those of the SDP in the INVITE message illustrated in FIG. 3 above, except that the port number of line ‘m=’ or the IP address of line ‘c=’ is different. As described above, since line ‘m=’ in the SDP of the INVITE message describes ‘newprint1,’ a terminal, which transmitted the INVITE message, functions as a server in the server-client model and a terminal, which transmitted ‘200 OK,’ functions as a client in the server-client model. In this processing for the establishment of the session, the printing apparatus terminal 30 functions as a server (i.e., a passive part) in the server-client model, and the posting server 20 functions as a client (i.e., an active part) in the server-client model.

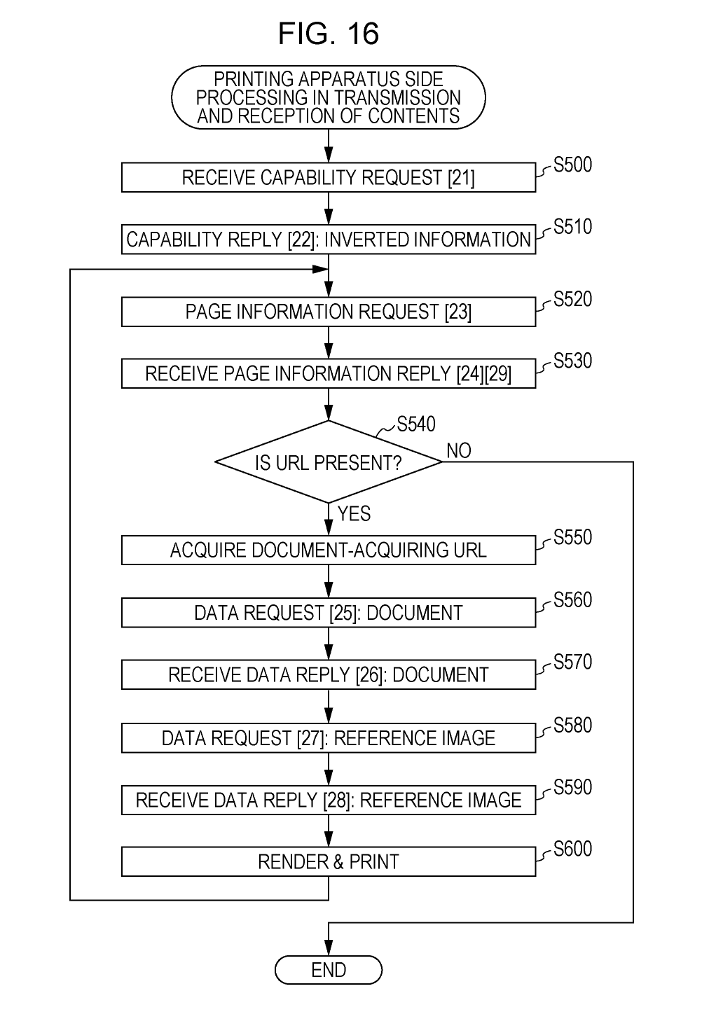

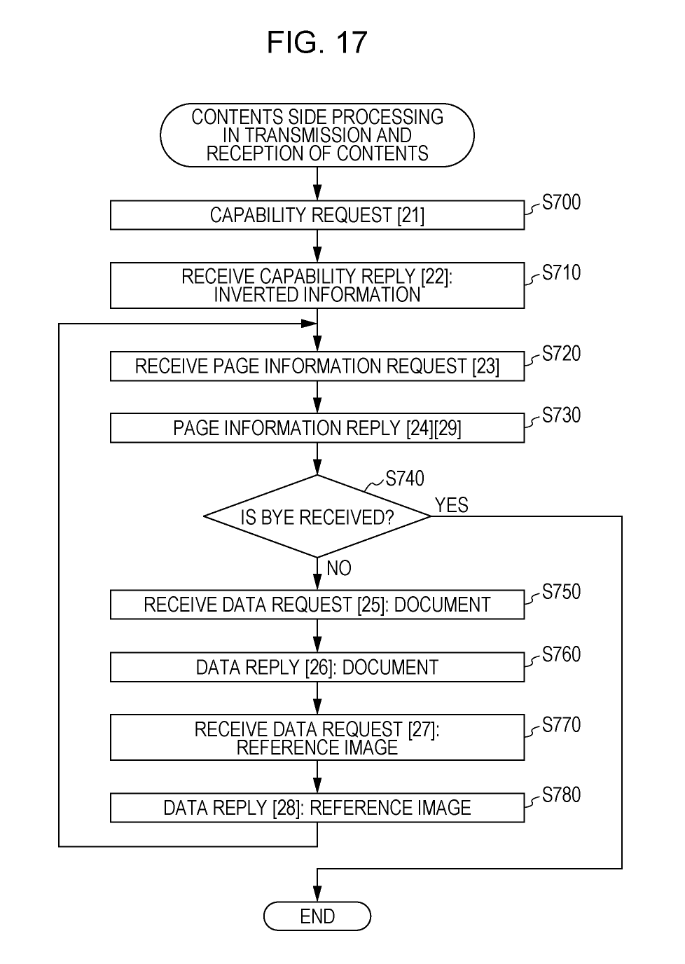

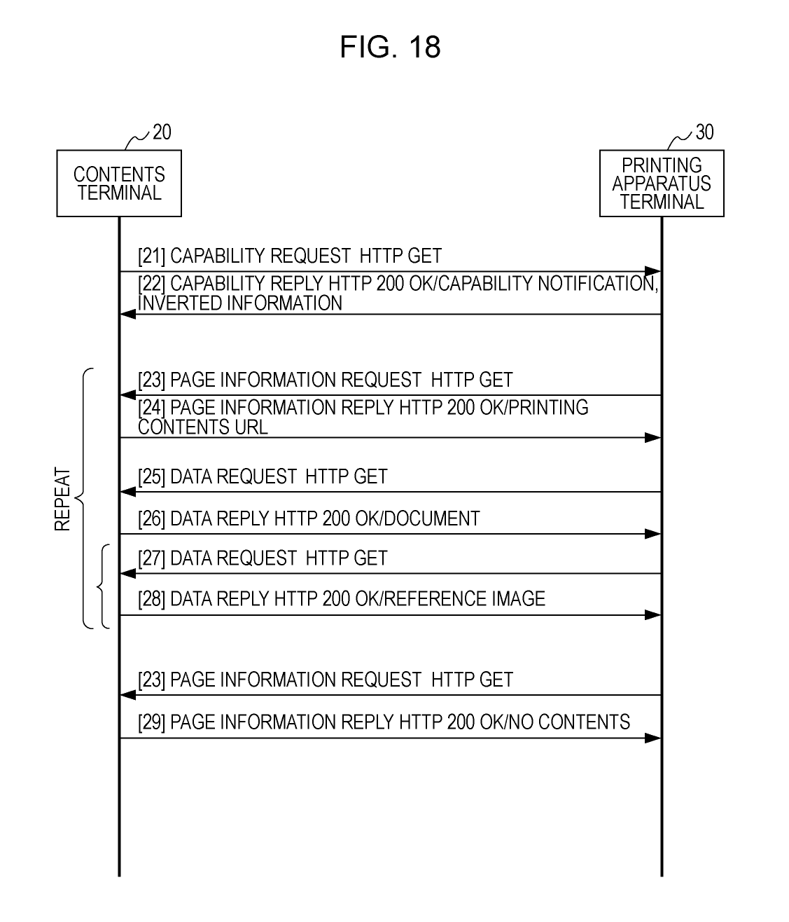

FIG. 16 is a flowchart showing an example of printing apparatus-side processing in the transmission and reception of printing contents performed by the printing apparatus terminal 30 when the printing contents are transmitted from the posting server 20 to the printing apparatus terminal 30, FIG. 17 is a flowchart showing an example of contents-side processing in the transmission and reception of the printing contents performed by the posting server 20 when the printing contents are transmitted from the posting server 20 to the printing apparatus terminal 30, and FIG. 18 is an explanatory view showing an example of sequences when the printing contents are transmitted from the posting server 20 to the printing apparatus terminal 30. For the sake of convenient explanation, a description will be given of the transmission and reception and the printing of the printing contents based on the sequences shown in FIG. 18, by referring to the printing apparatus-side processing in the transmission and reception of the contents shown in FIG. 16 and the contents-side processing in the transmission and reception of the contents shown in FIG. 17. In addition, as described above, when the session is established in order to perform the transmission and reception of the printing contents, the printing apparatus terminal 30 functions as a server in the server-client model and the posting server 20 functions as a client in the server-client model since the INVITE message is being transmitted from the printing apparatus terminal 30. Thus, the printing apparatus terminal 30 is standing by for a request from the posting server 20.

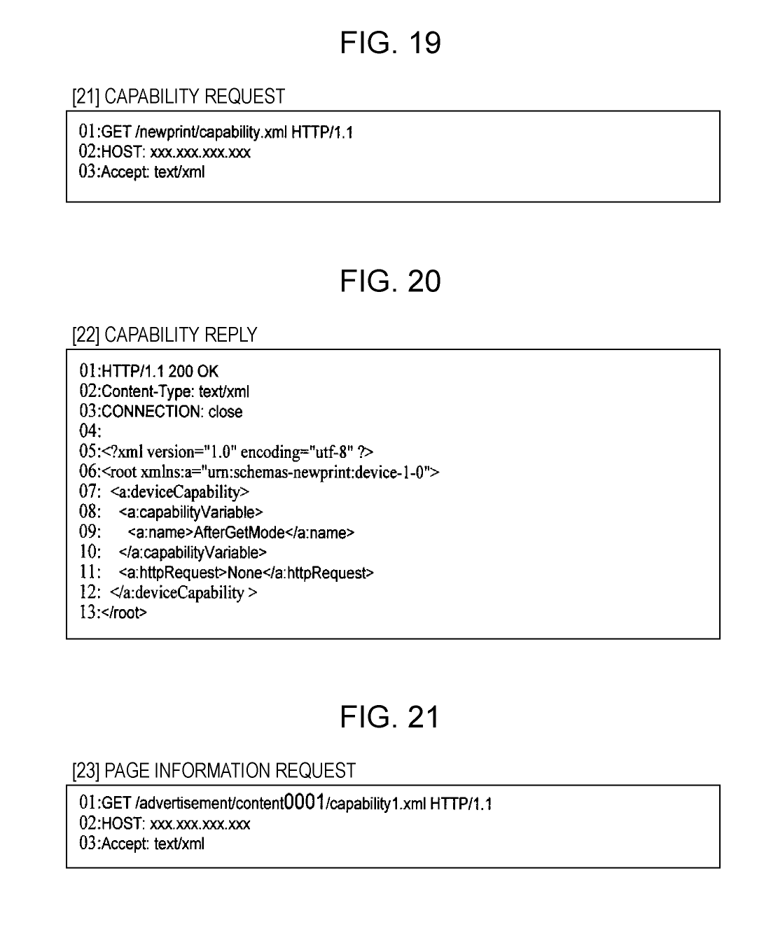

When the session is established, the posting server 20 performs a capability request by transmitting a capability request message to the printing apparatus terminal 30 (step S700 in FIG. 17 and step S500 in FIG. 16), and the printing apparatus terminal 30 performs a capability reply by transmitting a capability reply message to the posting server 20 in response to the capability request (step S510 in FIG. 16 and step S710 in FIG. 17). An example of the capability request message is shown in FIG. 19. The capability request message shown in FIG. 19 is the same as the capability request message shown in FIG. 8. An example of the capability reply message is shown in FIG. 20. ‘AfterGetMode’ in line 09 of the capability reply message is information (i.e., inversion information) that identifies the conversion of the mode in this exemplary embodiment. ‘AfterGetMode’ is defined to exchange the server and the client in the server-client model, so that a terminal, which has been functioning as a server up to that time, is set to function as a client and a terminal, which has been functioning as a client up to that time, is set to function as a server. Thus, the printing apparatus terminal 30 functions as a client in the server-client model as it transmits the capability request message, which describes ‘AfterGetMode’ as the inversion information, and the posting server 20 functions as a server in the server-client model from the point in time that it receives the capability request message and recognizes ‘AfterGetMode’ as the inversion information. Thus, the posting server 20 is standing by for a request from the printing apparatus terminal 30, and the IP address of the posting server 20 is used as the IP address of a host.

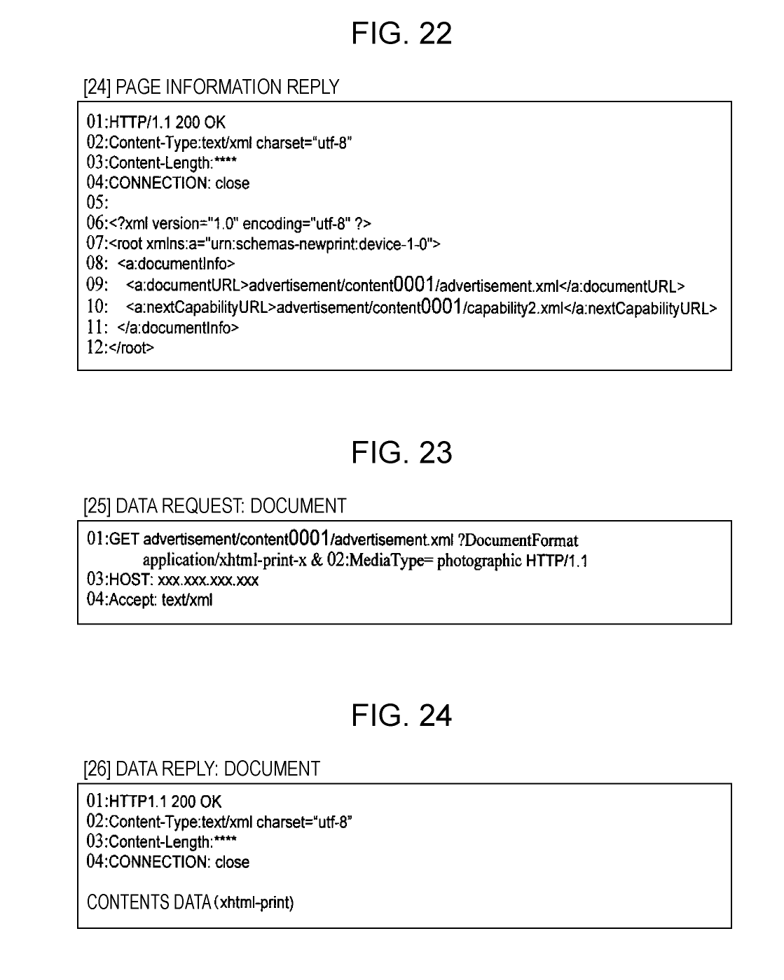

As such, when the server and the client are exchanged, the printing apparatus terminal 30 which functions as a client performs a page information request by transmitting a page information request message to the posting server 20 using a URL (‘advertisement/content/capability1.xml’ in line 09 of FIG. 13) in the list of printing contents (step S520 in FIG. 16 and step S720 in FIG. 17), and the posting server 20 performs a page information reply by transmitting a page information reply message to the printing apparatus terminal 30 in response to the page information request (step S730 in FIG. 17 and step S530 in FIG. 16). An example of the page request message is shown in FIG. 21. It can be seen that ‘advertisement/content0001/capability1.xml’ described in line 01 of the page information request message is the same as ‘advertisement/content0001/capability1.xml’ in line 11 of the data reply message, which acquires the list of printing contents shown in FIG. 13. An example of the page information reply message is shown in FIG. 22. It can be seen that line 09 of the page information reply message describes a URL ‘advertisement/content0001/advertisement.xml’ of a document as a printing content, and that line 10 describes a URL ‘advertisement/content0001/capability2.xml’ of the next one of the printing contents. When the page information reply message is received from the posting server 20, the printing apparatus terminal 30 acquires the URL of the document of the printing contents and/or the URL of the next page from the page information reply message if they are present in the page information reply message (step S540 and S550 in FIG. 16).

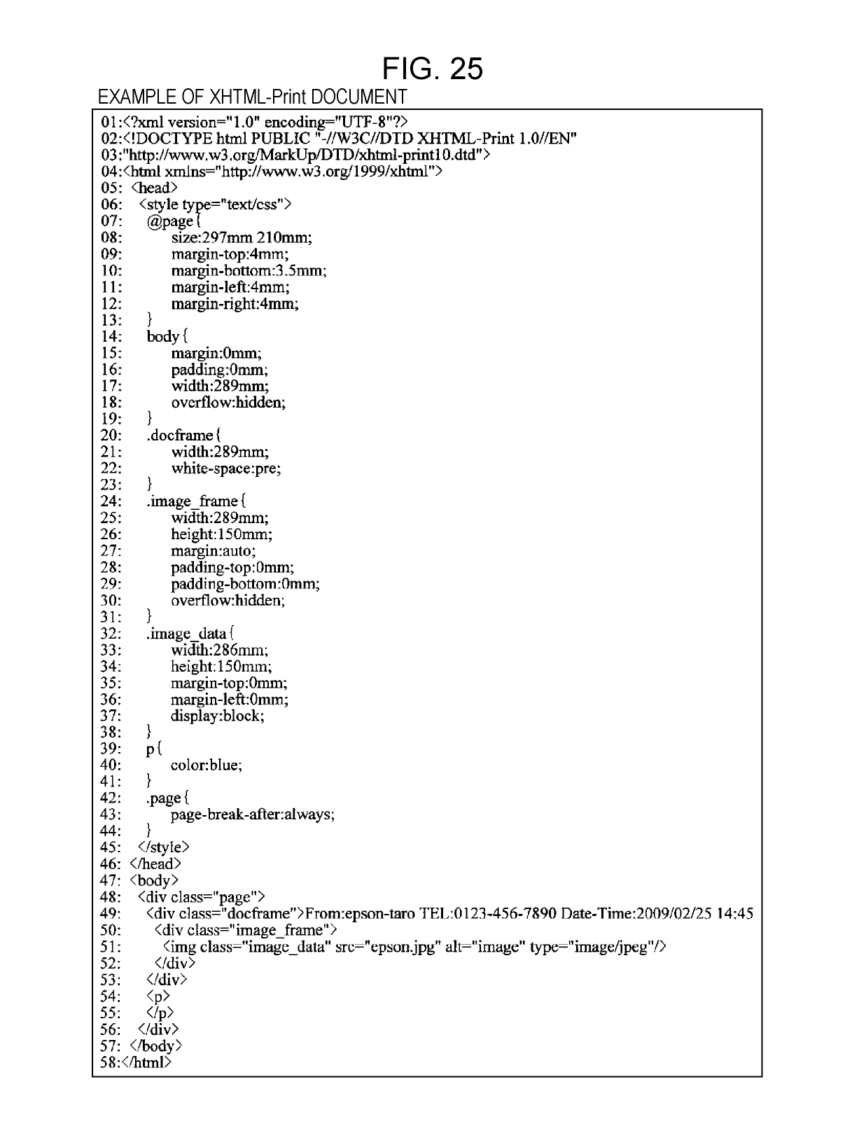

Next, the printing apparatus terminal 30 performs a data request by transmitting a data request message using the acquired URL (‘advertisement/content0001/advertisement.xml’ in line 09 of the page information reply message in FIG. 22) to the posting server 20 (step S560 in FIG. 16 and step S750 in FIG. 17), and the posting server 20 performs a data reply by transmitting a data reply message and data of the document to the printing apparatus terminal 30 (step 760 in FIG. 17 and step S570 in FIG. 16). An example of the data request message is shown in FIG. 23. It can be seen that ‘advertisement/content0001/advertisement.xml’ described in line 01 of the data request message is the same as ‘advertisement/content0001/advertisement.xml’ in line 09 of the page information reply message in FIG. 22. Line 01 of the data request message indicates that data, which has XHTML-Print ‘application/xhtml-print-x’ as a documentary format ‘DocumentFormat’ and ‘stationery’ as a media type ‘MediaType,’ is requested. An example of the data reply message is shown in FIG. 24. The posting server 20 transmits an XHTML-Print document as contents data on the data reply message. An example of the XHTML-Print document is shown in FIG. 25. In this example, the location information of an image data is a URL that is described as “epson.jpg” in line 51. The URL is described in a plurality of lines since a plurality of image data is present. In addition, as described above, the URL is a relative address with respect to the IP address of the posting server 20.

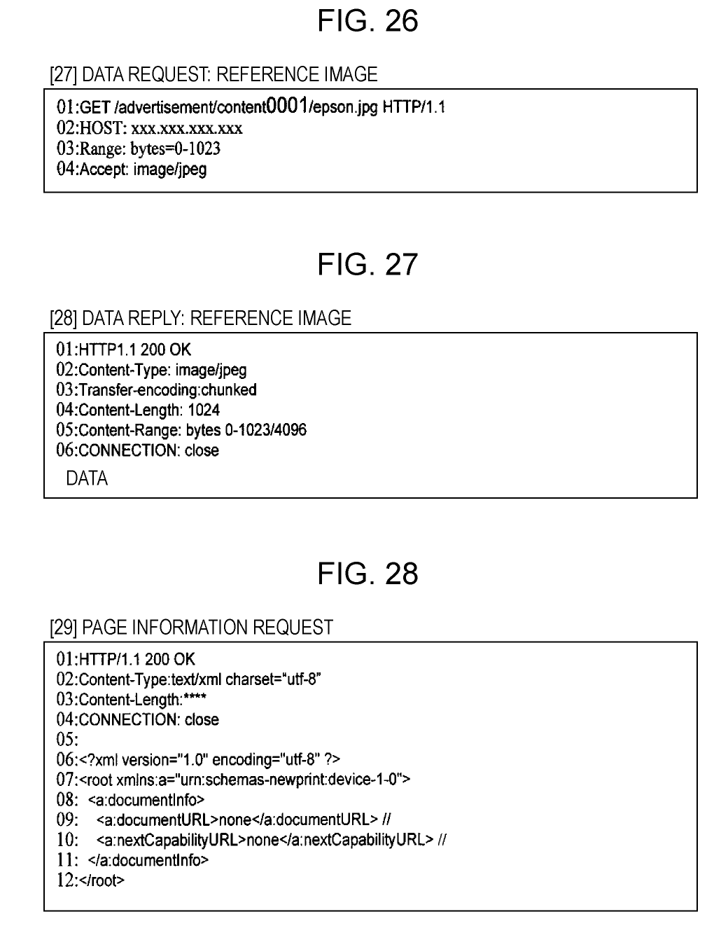

When the transmitted XHTML-Print document is received, the printing apparatus terminal 30 performs a data request by acquiring location information (URL that is described as “epson.jpg” in line 51 of FIG. 25) of the image data by scanning the received XHTML-Print document, and transmitting data request messages, the number of which is the same as that of the image data, in order to acquire the image data using the URL (step S580 in FIG. 16 and step S770 in FIG. 17). In response to the data request, the posting server 20 performs a data reply by transmitting data reply messages, the number of which is the same as that of the data request messages, and a corresponding image data to the printing apparatus terminal 30 (step S780 in FIG. 17 and step S590 in FIG. 16). An example of the data request message is shown in FIG. 26. It can be seen that “epson.jpg” described in line 01 of the data request message is the same as “epson.jpg” in line 51 of the XHTML-Print document in FIG. 25. ‘Range’ in line 03 is to designate data of the image data, which is supposed to the transmitted and received. In this exemplary embodiment, a description ‘bytes=0-1023 ’ designates 1024 bytes from 0^{th} byte to 1023^{rd} byte of the image data. This range is set in the range of a printing memory capacity, which is allocated to the print data, among the total capacity of the memory 36 of the printing apparatus terminal 30. In addition, if the printing memory capacity, which is allocated to the memory 36 of the printing apparatus terminal 30, is sufficient, ‘Range’ in line 03 may be omitted. In this case, all of the image data is designated. An example of the data reply message is shown in FIG. 27. In the data reply message, ‘Content-Length: 1024 ’ in line 04 indicates that the data length is 1024 bytes and ‘Content-Range: bytes 0-1023/4096 ’ in line 05 indicates that 1024 bytes from 0^{th} byte to 1023^{rd} byte among the total amount of data 4096 bytes are transmitted. The posting server 20 transmits the data, described in ‘Range’ in line 03 of the data request message, on the data reply message to the printing apparatus terminal 30. Then, the data request and the data reply are performed repeatedly until all the printing of the image data comes to an end.

When the image data is acquired as above, the printing apparatus terminal 30 performs rendering and printing image data by the printing processor 34, based on the acquired XHTML-Print document and the acquired image data (step S600). The printing apparatus terminal 30 performs a page information request to the posting server 20 using the URL ‘advertisement/content0001/capability2.xml’ (see line 10 in FIG. 22) of the next page, which is acquired by the page information reply from the posting server 20 in response to the page information request to the posting server 20 (step S520 in FIG. 16 and step S720 in FIG. 17). As long as the URL of the printing contents data or the URL of the next printing content is present in the page information reply message, the processing of steps S520 to S600 in FIG. 16 and the processing of steps S720 to S780 in FIG. 17, that is, sequences [23] to [28] in FIG. 18 are repeated.

If neither the URL of the printing contents data nor the URL of the next printing content is present in the page information reply message received from the posting server 20, the printing apparatus terminal 30 determines that the transmission of the printing contents has come to an end (step S540 in FIG. 16), and transmits ‘BYE’ (see FIG. 15) to the posting server 20 in order to close the session. FIG. 28 shows an example of the page information reply message that is transmitted from the posting server 20 in response to the page information request from the printing apparatus terminal 30 when the transmission of the printing contents comes to an end. In the page information reply message, like the page information reply message in FIG. 14, ‘none’ in line 09 and ‘none’ in line 10 indicate that neither the URL of the printing contents data nor the URL of the next page is present. When ‘BYE’ is received (step S740 in FIG. 17), the posting server 20 transmits ‘200 OK’ to the printing apparatus terminal 30 in order to close the session. The transmission of ‘BYE’ and ‘200 OK’ is the same as described above.

According to the printing system and the printing apparatus terminal 30 of this exemplary embodiment as described above, when ‘newprint1,’ which is for identifying that the transmission and reception of printing contents data is included, is described in line ‘m=’ as a content of the SDP of the INVITE message in the establishment of the session, the posting server 20 functions as a server in the server-client model and the printing apparatus terminal 30 functions as a client in the server-client model, so that the posting server 20 transmits the list of printing contents in response to the request from the printing apparatus terminal 30. Thus, it is possible to properly transmit the list of printing contents by the printing apparatus terminal 30. In addition, when the printing apparatus terminal 30 receives and prints the printing content included in the list of printing contents, the printing apparatus terminal 30 establishes the session is by transmitting the INVITE message. In the capability reply in response to the capability request from the posting server 20, ‘AfterGetMode’ is described as inversion information that sets a terminal, which has been functioning as a server, to function as a client and a terminal, which has been functioning as a client, to function as a server. Thus, the posting server 20 is set to function as a server in the server-client model, and the printing apparatus terminal 30 is set to function as a client in the server-client model. As such, it is possible to transmit and receive printing contents in the list of printing contents and the printing apparatus terminal 30 can receive printing contents and print the received printing contents. That is, the transmission and reception of the printing contents can be performed according to the performance of the printing apparatus terminal 30. This, as a result, makes it possible to transmit and receive the list of printing contents via the IP network, more properly transmit and receive the printing content included in the list of printing contents, and print the received printing content.

In the printing system according to an exemplary embodiment, the posting server 20 corresponds to the ‘contents terminal,’ the printing apparatus terminal 30 corresponds to the ‘printing apparatus terminal,’ and the IP network 10 corresponds to the ‘IP network.’ In the posting server 20 and the ‘contents terminal,’ the user agent SIPUA 23, which establishes the session based on the transmission and reception of the INVITE message including ‘newprint1’ described in line ‘m=’ as a content of the SDP of the INVITE message, for identifying as including the transmission and reception of a printing content, corresponds to a ‘contents-side connection establishment processor.’ The controller 22, which functions as a server in the server-client model due to the description ‘newprint1’ and performs the contents-side processing in the transmission and reception of contents shown in FIG. 6 by transmitting a list of printing contents to the printing apparatus terminal 30 in response to a request from the printing apparatus terminal 30, corresponds to a ‘list transmitter.’ The controller 22, which functions as a client in the server-client model due to the description ‘newprint1’ and sends a capability request to the printing apparatus terminal 30, functions as a server in the server-client model based on a capability reply including the description ‘AfterGetMode’ as inversion information, received in response to the capability request, and thus performs the contents-side processing in the transmission and reception of contents shown in FIG. 17 by transmitting printing content included in the list of printing contents to the printing apparatus terminal 30 in response to a request from the printing apparatus terminal 30, corresponds to a ‘contents transmitter.’ In the printing apparatus terminal 30 and the ‘printing apparatus terminal,’ the memory 36 corresponds to a ‘memory,’ and the printing processor 34 corresponds to a ‘printing processor.’ The user agent (SIPUA) 33, which establishes the session based on the transmission and reception of the INVITE message including ‘newprint1’ described in line ‘m=’ as a content of the SDP of the INVITE message, for identifying as including the transmission and reception of the printing contents, corresponds to a ‘printing apparatus-side connection establishment processor.’ The controller 32, which functions as a client in the server-client model due to the description ‘newprint1’ and performs the printing apparatus-side processing in the transmission and reception of the list shown in FIG. 5 by receiving data transmitted from the posting server 20 in response to a request for the list of printing contents, corresponds to a ‘list receiver.’ The controller 32, which functions as a server in the server-client model due to the description ‘newprint1’ and receives a capability request from the posting server 20, functions as a client in the server-client model based on the transmission of a capability reply including the description ‘AfterGetMode’ as inversion information to the posting server 20 in response to the capability request, and thus performs the printing apparatus-side processing in the transmission and reception of contents shown in FIG. 16 by receiving and printing the printing content transmitted from the posting server 20 in response to a request for the printing content included in the list of printing contents, corresponds to a ‘contents receiver-and-printing controller.’ In addition, in the printing apparatus terminal according to an exemplary embodiment of the invention, the memory 36 corresponds to a ‘memory,’ and the printing processor 34 corresponds to a ‘printing processor.’ The user agent (SIPUA) 33, which establishes the session based on the transmission and reception of the INVITE message including ‘newprint1’ described in line ‘m=’ as a content of the SDP of the INVITE message, for identifying as including the transmission and reception of the printing contents, corresponds to a ‘receiving-side connection establishment processor.’ The controller 32, which functions as a client in the server-client model due to the description ‘newprint1’ and performs the printing apparatus-side processing in the transmission and reception of the list shown in FIG. 5 by receiving data transmitted from the posting server 20 in response to a request for the list of printing contents, corresponds to a ‘list acquirer.’ The controller 32, which functions as a server in the server-client model due to the description ‘newprint1’ and receives a capability request from the posting server 20, functions as a client in the server-client model based on the transmission of a capability reply including the description ‘AfterGetMode’ as inversion information to the posting server 20 in response to the capability request, and thus performs the printing apparatus-side processing in the transmission and reception of contents shown in FIG. 16 by receiving and printing the printing content transmitted from the posting server 20 in response to a request for printing content included in the list of printing contents, corresponds to a ‘contents receiver-and-printing controller.’

The printing system or the printing apparatus terminal 30 according to an exemplary embodiment of the invention has described as printing the printing content by receiving an XHTML-Print document as printing content included in a list of printing contents and acquiring the URL of an image data described in the XHTML-Print document. However, it is possible to receive and print the printing content, in which the document format ‘DocumentFormat’ is Tagged Image File Format (tiff) instead of the XHTML-Print format. In this case, it is also possible to receive and print an amount of data in the range of the printing memory capacity allocated to the printing data of the total capacity of the memory 36 of the printing apparatus terminal 30, instead of receiving the data page by page. In this case, a description such as ‘Range: bytes=0-1023,’ which designates the amount of data to be transmitted or received, is added to the data request message shown in FIG. 23. The ‘Range’ designates the data to be transmitted and received of the printing contents data. In the above-described example, the description ‘bytes=0-1023 ’ designates 1024 bytes from 0^{th} byte to 1023^{rd} byte for one page as the amount of data to be transmitted and received. Here, the data reply message in corresponding FIG. 24 describes ‘Content-Length: 1024’ and ‘Content-Range: bytes 0-1023/4096.’ The description ‘Content-Length: 1024 ’ indicates that the amount of data is 1024 bytes, and the description Content-Range: bytes 0-1023/4096′ indicates that 0^{th} byte to 1023^{rd} byte among a total data of 4096 bytes are transmitted and received. When the amount of data is designated to the printing content to be received, the printing content can be received and printed by the designated amount of data. As a result, even if the memory 36 of the printing apparatus terminal 30 has a small printing memory capacity, which is allocated to printing data, of the total capacity, it is possible to more properly transmit, receive, and print the printing content.

The printing system and the printing apparatus terminal 30 according to an exemplary embodiment of the invention have been described that the posting server 20 transmits the list of printing contents to the printing apparatus terminal 30 by establishing the session. However, it is also possible to transmit the list of printing contents from the posting server 20 to the printing apparatus terminal 30 via an E-mail. In addition, it is also possible to transmit the list of printing contents from other devices rather than the posting server 20 to the printing apparatus terminal 30.

The printing system according to an exemplary embodiment of the invention has been described that the posting server 20 functions as a server in the server-client model and the printing apparatus terminal 30 functions as a client in the server-client model when ‘newprint1,’ which is for identifying as including the transmission and reception of the printing contents data, is described in line ‘m=’ as the content of an SDP of the INVITE message in the establishment of the session. The identifier is not limited to ‘newprint1’ but can be any form of description as long as it identifies as including the transmission and reception of the printing contents data in the INVITE message.

The printing apparatus terminal 30 according to an exemplary embodiment of the invention has been described as being provided with both the scanning processor 35 and the memory card driver 37. The printing apparatus terminal 30 may have one of the scanning processor 35 and the memory card driver 37 or may have neither of them.

The posting server 20 according to an exemplary embodiment has been described as including the printing processor 24, the scanning processor 25, and the memory card driver 27. However, the posting server 20 may have only some of the processor 24, the scanning processor 25, and the memory card driver 27 or may have neither of them as long as it stores the printing contents data to be transmitted. In other words, the posting server 20 can have any configuration as long as it can transmit the printing contents data and the list of printing contents.

While the present invention has been described with reference to certain exemplary embodiments thereof, the present invention is not intended to be limited by the above illustrated embodiments. Rather, various changes in form can be made without departing from the scope of the present invention.

The present invention is applicable to the manufacturing industry of printing systems, print apparatus terminals, and the like.

What is claimed is:

1. A printing system including a contents terminal transmitting printable printing contents and a printing apparatus terminal receiving and printing the printing contents, which are connected to the printing system via an Internet protocol network,
wherein the contents terminal comprising:
a contents-side connection establishment processor, which establishes a connection with the printing apparatus terminal via the Internet protocol network based on transmission and reception of a connection request message having printing identification information, which is for transmission and reception of the printing contents;
a list transmitter, which functions as a server in a server-client model and transmits a list of the printing contents to the printing apparatus terminal in response to a request from the printing apparatus terminal when the connection with the printing apparatus terminal is established based on the transmission of the connection request message having the printing identification information; and
a contents transmitter, which functions as a client in the server-client model and sends an information request to the printing apparatus terminal when the connection with the printing apparatus terminal is established based on the reception of the connection request message having the printing identification information, and which functions, if a reply from the printing apparatus terminal in response to the information request has inversion information, as a server in the server-client model from a point in time when the inversion information is recognized, and transmits the printing contents to the printing apparatus terminal in response to a request from the printing apparatus terminal, and
wherein the printing apparatus terminal comprising:
a memory capable of temporarily storing data;
a printing processor, which prints the print data;
a printing apparatus-side connection establishment processor, which establishes a connection with the contents terminal via the Internet protocol network based on transmission and reception of the connection request message having the printing identification information;
a list receiver, which functions as a client in the server-client model and receive the list of printing contents from the contents terminal by sending a request for transmission of the list of printing contents to the contents terminal when the connection with the contents terminal is established based on the reception of the connection request message having the printing identification information;
a contents receiver-and-printing controller, which functions as a server in the server-client model and sends a reply having the inversion information in response to the information request from the contents terminal when the connection with the contents terminal is established based on the transmission of the connection request message having the printing identification information, and which functions, from a point in time when the reply having the inversion information is sent, as a client in the server-client model, receives the printing contents from the contents terminal by sending a request for transmission of printing content included in the list of printing contents to the contents terminal, and controls the printing processor to the contents terminal so that the received printing content is printed.

2. The printing system according to claim 1,
wherein the contents receiver-and-printing controller of the printing apparatus terminal receives data multiple times by sending, multiple times, a data transmission request for an amount of data to the contents terminal, the amount being in a range of a printing memory capacity, which is allocated to the print data, of a memory capacity of the memory, and controls, whenever the data is received, the printing processor so that the received data is printed by the printing processor, and
wherein the printing contents transmitter of the contents terminal transmits the printing contents by transmitting the data multiple times in response to the data transmission request from the printing apparatus terminal.

3. The printing system according to claim 1, wherein the contents receiver-and-printing controller of the printing apparatus terminal acquires, if a description document, which describes location information indicating a storage location of image data included in the printing contents, is included, the image data based on the location information described in the description document.

4. A printing apparatus terminal, which is connected with a contents terminal, which transmits printable printing contents, via an Internet protocol network, receives the received printing contents from the contents terminal and prints the contents, the printing apparatus terminal comprising:
a memory capable of temporarily storing data;
a printing processor, which prints the print data;
a receiving-side connection establishment processor, which establishes a connection with the contents terminal via the Internet protocol network based on transmission and reception of a connection request message having printing identification information, which is for transmission and reception of the printing contents;
a list acquirer, which acquires a list of the printing contents; and
a contents receiver-and-printing controller, which functions as a server in the server-client model and sends a reply having the inversion information in response to an information request from the contents terminal when the connection with the contents terminal is established based on the transmission of the connection request message having the printing identification information, and which functions, from a point in time when the reply having the inversion information is sent, as a client in the server-client model, receives the printing contents from the contents terminal by sending a request for transmission of printing content included in the list of printing contents to the contents terminal, and controls the printing processor so that the received printing content is printed.

5. The printing apparatus terminal according to claim 4, wherein the list acquirer functions as a client in the server-client model and receives the list of printing contents from the contents terminal by sending a request for transmission of the list of printing contents to the contents terminal when the connection with the contents terminal is established based on the reception of the connection request message having the printing identification information.

6. The printing apparatus terminal according to claim 4, wherein the contents receiver-and-printing controller receives data multiple times by sending, multiple times, a data transmission request for an amount of data to the contents terminal, the amount being in a range of a printing memory capacity of a memory capacity of the memory, which is allocated to the print data, and controls, whenever the data is received, the printing processor so that the received data is printed by the printing processor.

7. The printing apparatus terminal according to claim 4, wherein the contents receiver-and-printing controller acquires, if a description document, which describes location information indicating a storage location of image data included in the printing contents, is included, the image data based on the location information described in the description document.
